(19) United States
(12) Patent Application Publication
(10) Pub. No.: US 2018/0217102 A1
(43) Pub. Date: Aug. 2, 2018

(54) ULTRASONIC FLOW METER CONFIGURED TO DETECT IMPURITIES IN A FLUID

(71) Applicants: Jared Negussie Wolde Michael, New York, NY (US); Daniel Gizaw, Belleville, MI (US); Naomi Gizaw, Novi, MI (US); Grum Ketema, Arlington, VA (US); Mekdem Getahun, Addis Ababa (ET); Fikirte Mekonen, Addis Ababa (ET)

(72) Inventors: Jared Negussie Wolde Michael, New York, NY (US); Daniel Gizaw, Belleville, MI (US); Naomi Gizaw, Novi, MI (US); Grum Ketema, Arlington, VA (US); Mekdem Getahun, Addis Ababa (ET); Fikirte Mekonen, Addis Ababa (ET)

(21) Appl. No.: 15/650,956

(22) Filed: Jul. 16, 2017

(30) Foreign Application Priority Data
Jan. 30, 2017 (ET) ET/P/17355

(51) Int. Cl. G01N 29/024

(52) U.S. Cl. CPC G01N 29/024; G01N 2291/011; G01N 2291/102; G01N 2291/02416; G01N 2291/022

(57) ABSTRACT

An ultrasonic flowmeter configured to detect impurities in a fluid, such as impurities in water. The flowmeter sends an ultrasonic signal through a flow tube and measures a deviation in a measured travel speed, which corresponds to a concentration of a measured impurity. The flow tube of the flowmeter can either have a straight configuration or a u-shaped configuration.

### CROSS-REFERENCE TO RELATED APPLICATIONS

This application claims the priority benefit of Ethiopian Provisional Application Et/P/17355 filed on Jan. 30, 2017, which is herein incorporated by reference in its entirety.

### TECHNICAL FIELD

The present disclosure relates to ultrasonic flow meters. More particularly, the disclosure discusses flow meters that can detect impurities in a fluid.

### BACKGROUND

The statements in this section merely provide background information related to the present disclosure. Accordingly, such statements are not intended to constitute an admission of prior art.

The World Health Organization (WHO) (World Health Organization) and U.S. Environmental Protection Agency (EPA) have set as a standard limits for various contaminants in drinking water. Hence, a need exists to measure drinking water contaminants in a consistent and cost-effective manner.

### BRIEF SUMMARY OF THE INVENTION

An ultrasonic flow meter as cited in this disclosure can comprise: at least one ultrasonic transducer; and a signal processing unit for processing ultrasonic signals received from the at least one ultrasonic transducer, wherein the signal processing unit is configured to detect at least one impurity in a fluid as a function of a deviation in a measured travel speed of an ultrasonic signal in the fluid.

The fluid flowing through the meter can be water or the like. The water can be distilled water, lake water, treated water for personal consumption, or the like.

The impurities can be an acid, fluoride, iron, lead, or a combination thereof.

The fluid can be measured across a range of fluid temperatures, including a range of 0-100 degrees centigrade for water.

The deviation in the measured ultrasonic wavelength can be between 1.5 and 2.0 meters per second.

The transducer can be mounted within a u-shaped tube, through which the fluid flows.

Alternately, the transducer can be mounted within a straight tube, through which the fluid flows.

The scope of the invention is defined by the claims, which are incorporated into this section by reference. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

### BRIEF DESCRIPTION OF THE DRAWINGS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention suggests. Accordingly:

FIG. 1A compares distilled water speed curve 101 to lead contaminant in distilled water with a 15 micro gram per liter concentration 102.

FIG. 1B compares distilled water speed curve 101 to iron in distilled water with a 0.5 mg per liter concentration 103.

FIG. 1C compares distilled water speed curve 101 to fluoride in distilled water with a 1.6 mg per liter concentration 104.

FIG. 1D compares distilled water speed curve 101 to a sulfuric acid solution with a pH of 5.8 105.

FIG. 2A is a box plot showing contaminants in distilled water at 20 degrees Celsius.

FIG. 2B is a graph of probability density curves of contaminants in distilled water at 20 degrees Celsius.

FIG. 2C is a count histogram of contaminants in distilled water at 20 degrees Celsius.

FIG. 3A is a box plot showing contaminants in distilled water at 30 degrees Celsius.

FIG. 3B is a graph of probability density curves of contaminants in distilled water at 30 degrees Celsius.

FIG. 3C is a count histogram of contaminants in distilled water at 30 degrees Celsius.

FIG. 4A is a box plot showing contaminants in distilled water at 40 degrees Celsius.

FIG. 4B is a graph of probability density curves of contaminants in distilled water at 40 degrees Celsius.

FIG. 4C is a count histogram of contaminants in distilled water at 40 degrees Celsius.

FIG. 5A is a box plot showing contaminants in distilled water at 50 degrees Celsius.

FIG. 5B is a graph of probability density curves of contaminants in distilled water at 50 degrees Celsius.

FIG. 5C is a count histogram of contaminants in distilled water at 50 degrees Celsius.

FIG. 6 is a cross-section bottom-view of a straight tube ultrasonic flow meter embodiment.

FIG. 7 is a cross-section bottom-view of a U-shaped tube ultrasonic flow meter embodiment.

FIG. 8 is a front view of a straight tube ultrasonic flow meter embodiment.

FIG. 9 is a bottom view of a straight tube ultrasonic flow meter embodiment.

FIG. 10 is a right-side view of a straight tube ultrasonic flow meter embodiment.

FIG. 11 is a left-back perspective view of a straight tube ultrasonic flow meter embodiment.

FIG. 12 is a right-front of a straight tube ultrasonic flow meter embodiment.

FIG. 13 is a front view without the enclosure cover of a straight tube ultrasonic flow meter embodiment.

FIG. 14 is a front view without the enclosure cover that shows a signal processing unit layout for a straight tube ultrasonic flow meter embodiment.

FIG. 15 is a top view top view of a straight tube ultrasonic flow meter embodiment.

FIG. 16 is cross-section bottom-view of a U-shaped tube ultrasonic flow meter embodiment that provides additional detail and gives cut-section locations.

FIG. 17 shows a first cut-section.

FIG. 18 shows a second cut-section.

FIG. 19 shows a third cut-section.

FIG. 20 shows a fourth cut-section.

FIG. 21 is a cross-section bottom-view of a straight tube ultrasonic flow meter embodiment that gives additional detail.

FIG. 22 is a perspective view of a reflector ring assembly.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Ultrasonic flow meters utilize an ultrasonic signal pulsed through a fluid traveling within a pipe. When the fluid is flowing the reflected ultrasonic signal is reflected with a Doppler effect (phase shift) that can be correlated to a fluid speed. The speed is multiplied by the cross sectional area of the pipe to derive a fluid flowrate.

The Doppler effect can also be measured as a change in the pulsed time of flight required for the ultrasonic signal to be sent and received. The pulsed time of flight can be affected by fluid temperature (which affects the fluid density), type of fluid, speed (or flowrate) of the fluid, and fluid impurities.

This disclosure describes an apparatus and method that correlates the existence and concentration of fluid impurities, based upon calibrated temperature and speed ranges for the apparatus and method. While any fluid can be used for the apparatus and method, water is the fluid used for the supporting data listed in this disclosure.

Test Environment and Assumptions: Throughout our procedure of contamination test we have two transducers (A and B) inside an ultrasonic flow water meter that are capable of transmitting and receiving ultrasonic waves. The waves are propagated through the liquid media that is contained in the pipe unit of the meter and the time it took for the wave to traverse from A to B and vice versa is recorded.

Using a basic formula ‘Distance=(Time)×(Speed)’ we achieve a high precision distance measurement from A to B (within 1/100th of a millimeter precision) by taking the time it takes for the ultrasonic wave to travel from A to B (within (+/−) 1/200 microseconds precision) and by using a standard table of speed of sound (in distilled water) versus temperature.

A test session lasts 20 seconds. Taking sample measurements every 0.2 second we collect 100 samples. During a session the temperature remains constant (within a unit of degree Celsius). Thermal expansion is avoided as a result and so the distance between A and B (within 1/100th of a millimeter precision) is held constant.

Types of contaminations and drinking water samples tested are: (a) Acid (with 5.8 pH level), (b) Fluoride (with 1.6 mg per liter concentration), (c) Iron (with 0.5 mg per liter concentration), and (d) Lead (with 15 micro gram per liter concentration).

Drinking water tested: Spring water with chemical components in mg/L listed below is tested. The speed of sound in such drinking water did not show much difference from that of distilled water. Consequently, we are able to deduce that toxic agents listed above (a)-(d) have more effect in changing the speed of sound than other non-harmful minerals in water.

Spring water components: (1) calcium 3.20, (2) magnesium 1.95, (3) potassium 1.65, (4) bicarbonate 73.20, (5) chloride 7.60, (6) total dissolved solids (TDS) 82.

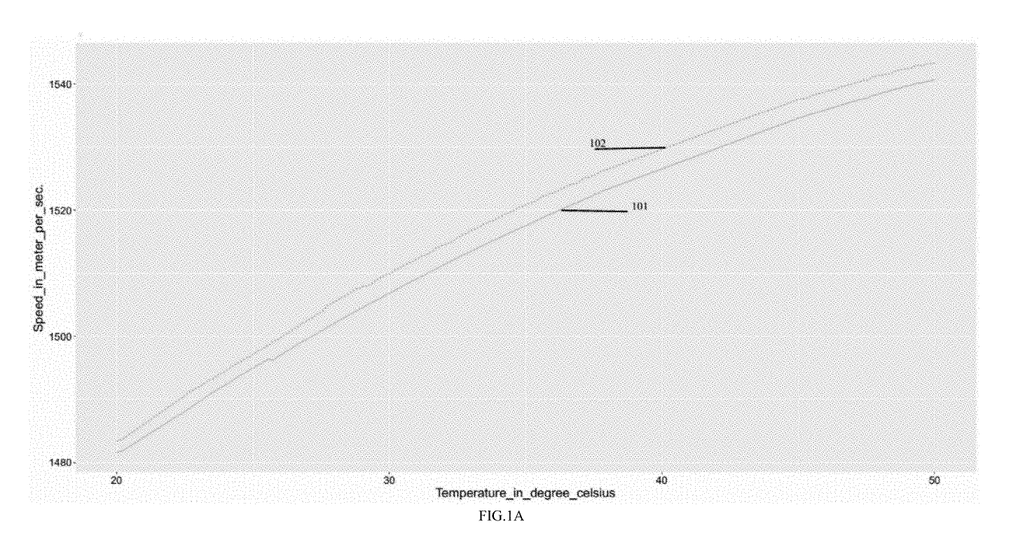

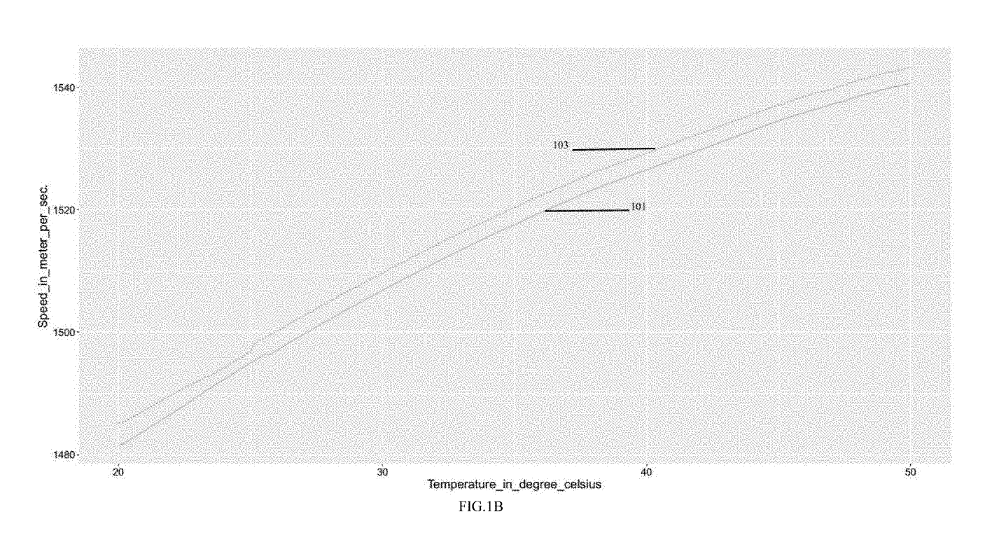

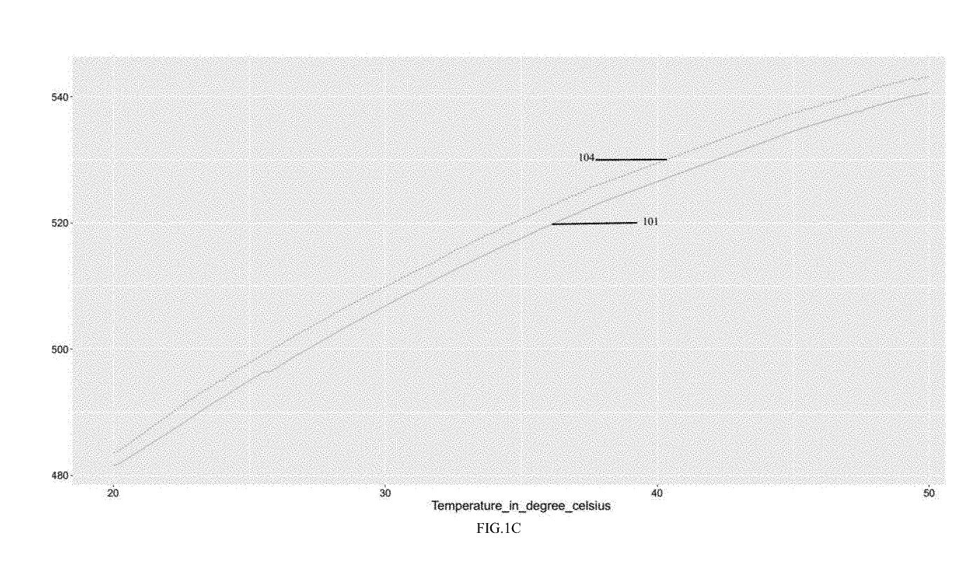

FIGS. 1A, 1B, 1C, and 1D depict the speed (in meters per second) of the ultrasonic wave as a function of temperature that varies from 20 to 50 degrees Celsius. Four types of contaminants in water as well as the distilled water speed curve are shown: distilled water speed curve 101; lead contaminant in distilled water with a 15 micro gram per liter concentration 102; iron in distilled water with a 0.5 mg per liter concentration 103; fluoride in distilled water with a 1.6 mg per liter concentration 104; and a sulfuric acid solution with a pH of 5.8 105. The Ultrasonic flow meter logs temperature and Time of Flight (TOF) to a data logging device with large memory. We control the temperature of the water using a programmable oven and take uninterrupted logs over several days. It is shown that ultrasound travels the slowest in distilled water and each contamination causes the speed to increase by a detectable amount. On the other hand, a safe drinking water sample with indicated mineral components remains close to distilled water. We have omitted plotting the drinking water speed curve as it is essentially indistinguishable from that of the distilled water.

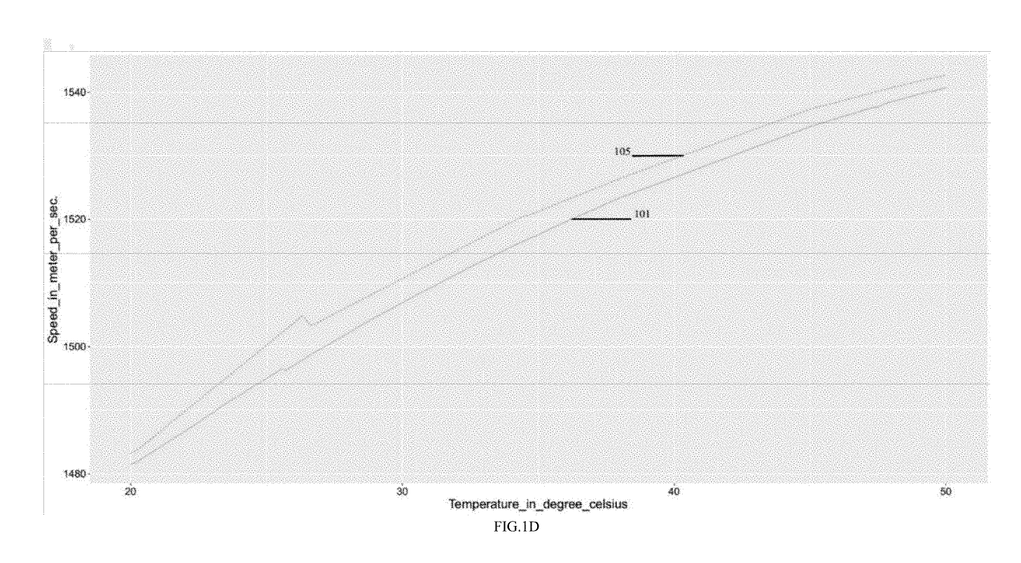

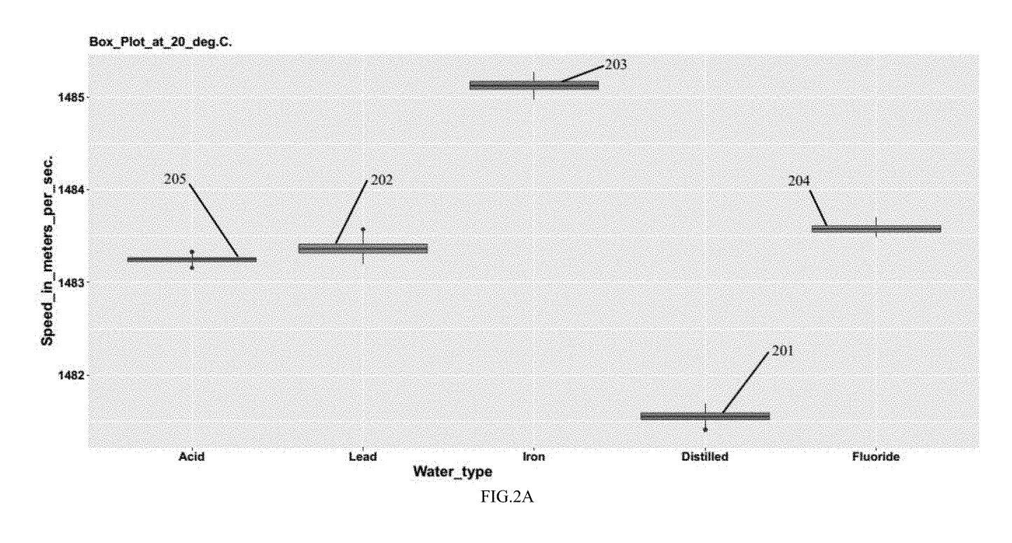

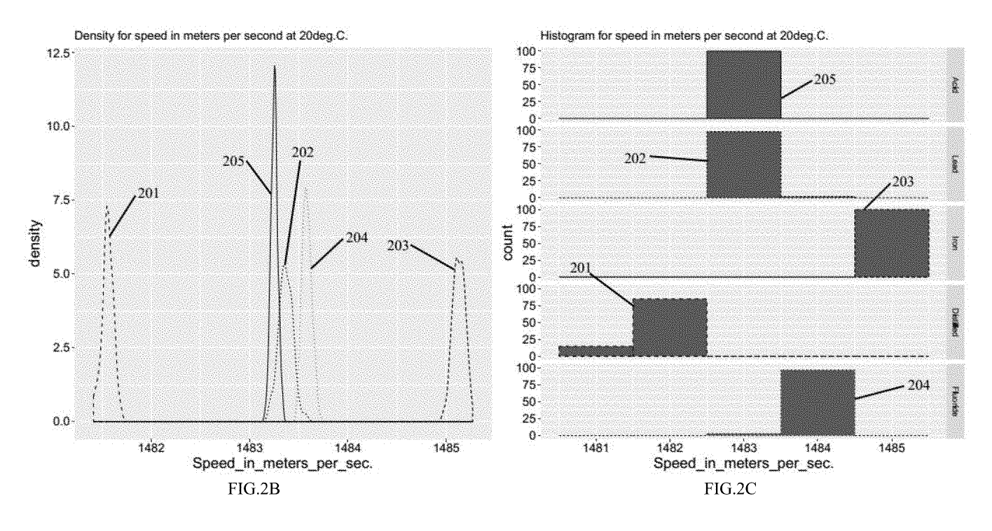

Fixing the temperature at 20, 30, 40, and 50 degrees Celsius we plot on FIGS. 2A, 2B, 2C, 3A, 3B, 3C, 4A, 4B, 4C, 5A, 5B, and 5C. Respectively, three graphs A, B, and C represent: “box plot” “probability density” and “count histogram”. These plots are constructed by running 100 similar experiments on the five types of water samples as shown by their respective legends.

FIG. 2A is a box plot showing contaminants in distilled water at 20 degrees Celsius; FIG. 2B is a graph of probability density curves of contaminants in distilled water at 20 degrees Celsius; and FIG. 2C is a count histogram of contaminants in distilled water at 20 degrees Celsius. Shown are data for distilled water at 20 degrees Celsius 201, lead contaminant in distilled water with a 15 micro gram per liter concentration at 20 degrees Celsius 202; iron in distilled water with a 0.5 mg per liter concentration at 20 degrees Celsius 203; fluoride in distilled water with a 1.6 mg per liter concentration at 20 degrees Celsius 204; and a sulfuric acid solution with a pH of 5.8 at 20 degrees Celsius 205.

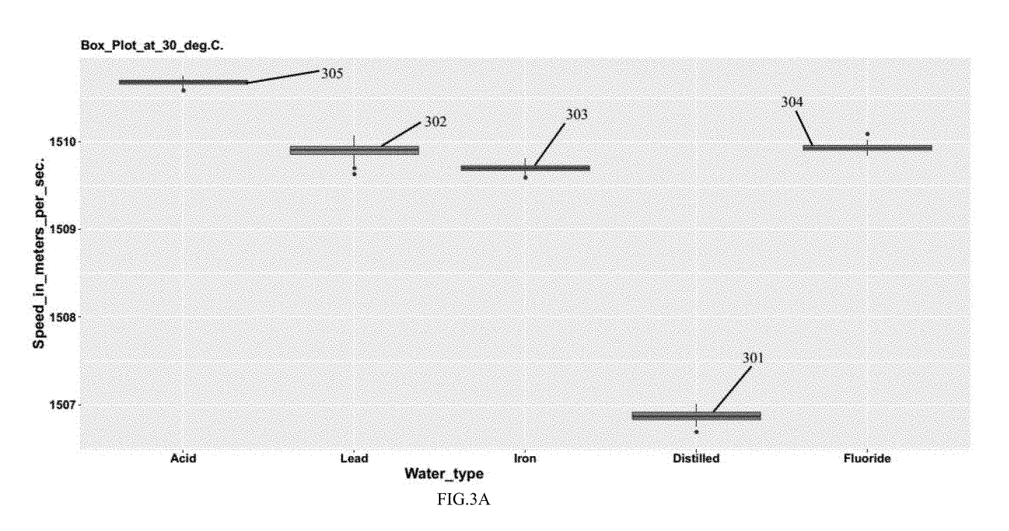

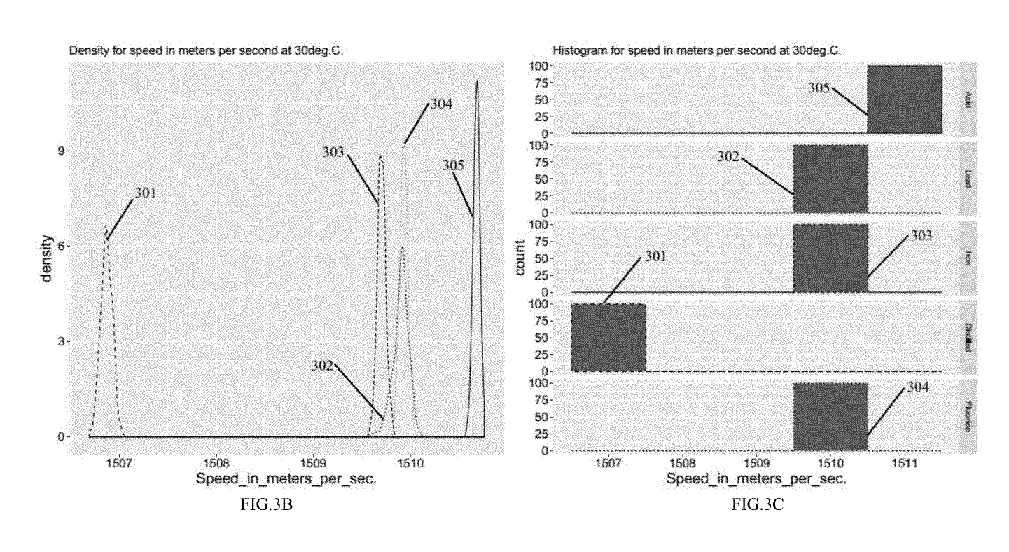

FIG. 3A is a box plot showing contaminants in distilled water at 30 degrees Celsius; FIG. 3B is a graph of probability density curves of contaminants in distilled water at 30 degrees Celsius; and FIG. 3C is a count histogram of contaminants in distilled water at 30 degrees Celsius. Shown are data for distilled water at 30 degrees Celsius 301, lead contaminant in distilled water with a 15 micro gram per liter concentration at 30 degrees Celsius 302; iron in distilled water with a 0.5 mg per liter concentration at 30 degrees Celsius 303; fluoride in distilled water with a 1.6 mg per liter concentration at 30 degrees Celsius 304; and a sulfuric acid solution with a pH of 5.8 at 30 degrees Celsius 305.

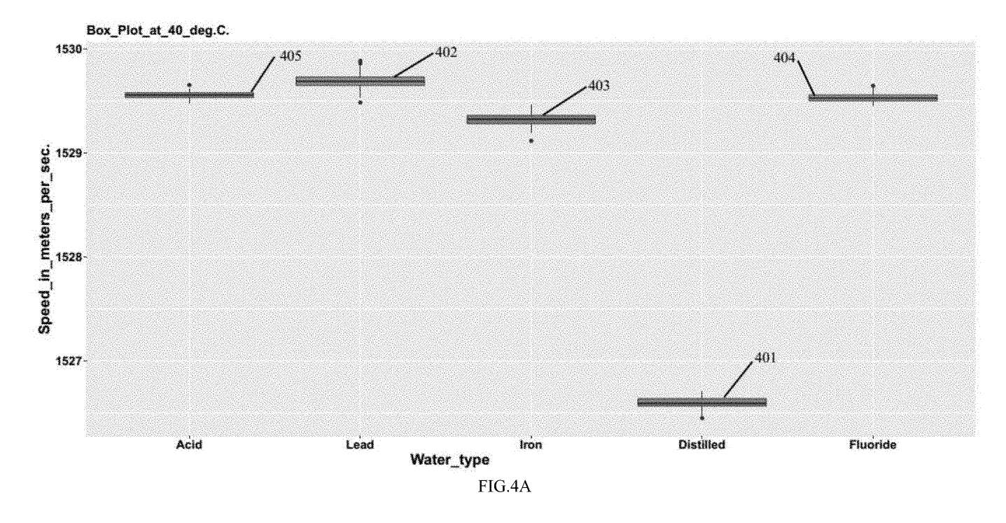

FIG. 4A is a box plot showing contaminants in distilled water at 40 degrees Celsius; FIG. 4B is a graph of probability density curves of contaminants in distilled water at 40 degrees Celsius; and FIG. 4C is a count histogram of contaminants in distilled water at 40 degrees Celsius. Shown are data for distilled water at 40 degrees Celsius 401, lead contaminant in distilled water with a 15 micro gram per liter concentration at 40 degrees Celsius 402; iron in distilled water with a 0.5 mg per liter concentration at 40 degrees Celsius 403; fluoride in distilled water with a 1.6 mg per liter concentration at 40 degrees Celsius 404; and a sulfuric acid solution with a pH of 5.8 at 40 degrees Celsius 405.

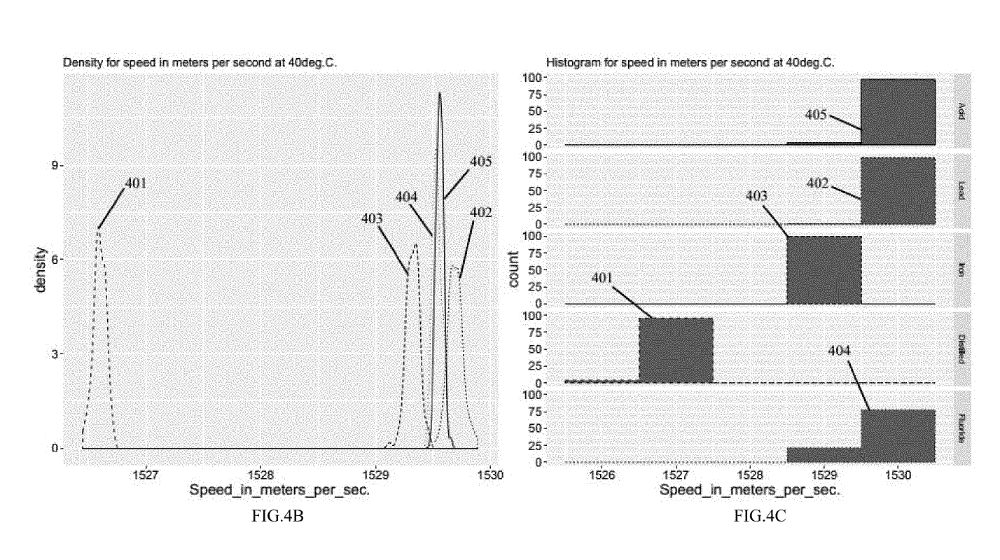

FIG. 5A is a box plot showing contaminants in distilled water at 50 degrees Celsius; FIG. 5B is a graph of probability density curves of contaminants in distilled water at 50 degrees Celsius; and FIG. 5C is a count histogram of contaminants in distilled water at 50 degrees Celsius. Shown are data for distilled water at 50 degrees Celsius 501, lead contaminant in distilled water with a 15 micro gram per liter concentration at 50 degrees Celsius 502; iron in distilled water with a 0.5 mg per liter concentration at 50 degrees Celsius 503; fluoride in distilled water with a 1.6 mg per liter concentration at 50 degrees Celsius 504; and a sulfuric acid solution with a pH of 5.8 at 50 degrees Celsius 505.

The maximum standard deviation we find using our ultrasonic flow water meter SWM-606 is about 0.09. However, the speed difference between a safe drinking water and any of the four contaminations is at least 1.7 meters per second. Since 1.7/0.09 is at least 18, we are able to fit at least nine sigma to the right of safe drinking water speed average, and at least nine sigma to the left of any of the listed contaminated samples speed average. This allows us to deduce that we can detect any one of the listed contaminations with nine sigma percentage. Explicitly, using the well-known percentile calculation equation

$$erf ( z ) = \frac{2}{\sqrt{π}} {\int }_{0}^{z} {e}^{- r 2} dt .$$

and substituting 9/√2 for z, we obtain more than 99.9999999999% probability of correctly detecting contamination. Note also that increasing the number of samples from 100 to a larger number and applying the well-established Central Limit Theorem of statistics, we are able to fit in more sigmas and thus obtain a higher percentage probability. However, what we have demonstrated is that 100 sampling is sufficient to exhibit our method of detection. Finally, note that our method is not limited only to the given six examples. Rather we have a general method that can be applied to a variety of contaminants. For demonstration purpose we have picked the presented six samples.

Table 1 below correlates the effect that each impurity has on distilled water at a given temperature in degrees Celsius. The water being measured has zero speed (flowrate). The data given in each column correspond to an ultrasonic signal travel speed in meters per second.

TABLE 1

| | | Lead | Iron | Fluoride | Sulfuric |
|---|---|---|---|---|---|
| | Distilled | 15 microgram | 0.5 mg | 1.6 mg | Acid |
| Temperature | water | per liter | per liter | per liter | pH 5.8 |
| 20 | 1481.55 | 1483.37 | 1485.14 | 1483.59 | 1483.25 |
| 20.1 | 1481.69 | 1483.52 | 1485.26 | 1483.75 | 1483.43 |
| 20.2 | 1481.82 | 1483.67 | 1485.38 | 1483.90 | 1483.60 |
| 20.3 | 1482.09 | 1483.97 | 1485.62 | 1484.21 | 1483.95 |
| 20.4 | 1482.37 | 1484.27 | 1485.87 | 1484.52 | 1484.29 |
| 20.5 | 1482.64 | 1484.57 | 1486.11 | 1484.83 | 1484.64 |
| 20.6 | 1482.91 | 1484.87 | 1486.36 | 1485.14 | 1484.99 |
| 20.7 | 1483.18 | 1485.17 | 1486.60 | 1485.45 | 1485.34 |
| 20.8 | 1483.46 | 1485.47 | 1486.85 | 1485.76 | 1485.68 |
| 20.9 | 1483.73 | 1485.77 | 1487.09 | 1486.06 | 1486.03 |
| 21 | 1484.00 | 1486.07 | 1487.34 | 1486.37 | 1486.38 |
| 21.1 | 1484.27 | 1486.37 | 1487.58 | 1486.68 | 1486.72 |
| 21.2 | 1484.55 | 1486.67 | 1487.83 | 1486.99 | 1487.07 |
| 21.3 | 1484.82 | 1486.97 | 1488.07 | 1487.30 | 1487.42 |
| 21.4 | 1485.09 | 1487.27 | 1488.31 | 1487.61 | 1487.77 |
| 21.5 | 1485.36 | 1487.57 | 1488.56 | 1487.92 | 1488.11 |
| 21.6 | 1485.63 | 1487.87 | 1488.80 | 1488.23 | 1488.46 |
| 21.7 | 1485.91 | 1488.17 | 1489.05 | 1488.54 | 1488.81 |
| 21.8 | 1486.18 | 1488.47 | 1489.29 | 1488.85 | 1489.15 |
| 21.9 | 1486.45 | 1488.77 | 1489.54 | 1489.16 | 1489.50 |
| 22 | 1486.72 | 1489.07 | 1489.78 | 1489.47 | 1489.85 |
| 22.1 | 1487.00 | 1489.37 | 1490.03 | 1489.77 | 1490.20 |
| 22.2 | 1487.27 | 1489.67 | 1490.27 | 1490.08 | 1490.54 |
| 22.3 | 1487.54 | 1489.97 | 1490.52 | 1490.39 | 1490.89 |
| 22.4 | 1487.81 | 1490.27 | 1490.76 | 1490.70 | 1491.24 |
| 22.5 | 1488.09 | 1490.57 | 1491.00 | 1491.01 | 1491.59 |
| 22.6 | 1488.38 | 1490.98 | 1491.23 | 1491.22 | 1491.93 |
| 22.7 | 1488.69 | 1491.30 | 1491.26 | 1491.67 | 1492.28 |
| 22.8 | 1489.01 | 1491.42 | 1491.69 | 1491.99 | 1492.63 |
| 22.9 | 1489.27 | 1491.75 | 1491.75 | 1492.14 | 1492.97 |
| 23 | 1489.57 | 1491.93 | 1491.98 | 1492.47 | 1493.32 |
| 23.1 | 1489.83 | 1492.15 | 1492.16 | 1492.73 | 1493.67 |
| 23.2 | 1490.15 | 1492.53 | 1492.43 | 1493.15 | 1494.02 |
| 23.3 | 1490.46 | 1492.79 | 1492.77 | 1493.30 | 1494.36 |
| 23.4 | 1490.75 | 1493.09 | 1492.80 | 1493.67 | 1494.71 |
| 23.5 | 1491.01 | 1493.17 | 1492.97 | 1493.90 | 1495.06 |
| 23.6 | 1491.27 | 1493.44 | 1493.27 | 1494.09 | 1495.41 |
| 23.7 | 1491.59 | 1493.81 | 1493.54 | 1494.40 | 1495.75 |
| 23.8 | 1491.81 | 1494.10 | 1493.76 | 1494.77 | 1496.10 |
| 23.9 | 1492.06 | 1494.25 | 1494.02 | 1494.97 | 1496.45 |
| 24 | 1492.31 | 1494.57 | 1494.13 | 1495.04 | 1496.79 |
| 24.1 | 1492.56 | 1494.87 | 1494.48 | 1495.29 | 1497.14 |
| 24.2 | 1492.86 | 1495.23 | 1494.68 | 1495.79 | 1497.49 |
| 24.3 | 1493.15 | 1495.48 | 1495.07 | 1496.03 | 1497.84 |
| 24.4 | 1493.43 | 1495.75 | 1495.24 | 1496.31 | 1498.18 |
| 24.5 | 1493.71 | 1495.97 | 1495.56 | 1496.54 | 1498.53 |
| 24.6 | 1493.96 | 1496.19 | 1495.76 | 1496.89 | 1498.88 |
| 24.7 | 1494.22 | 1496.55 | 1495.95 | 1497.19 | 1499.22 |
| 24.8 | 1494.52 | 1496.78 | 1496.31 | 1497.28 | 1499.57 |
| 24.9 | 1494.77 | 1496.85 | 1496.62 | 1497.56 | 1499.92 |
| 25 | 1495.01 | 1497.29 | 1496.76 | 1497.90 | 1500.27 |
| 25.1 | 1495.31 | 1497.50 | 1497.98 | 1498.12 | 1500.61 |
| 25.2 | 1495.59 | 1497.81 | 1498.31 | 1498.34 | 1500.96 |
| 25.3 | 1495.79 | 1497.98 | 1498.53 | 1498.63 | 1501.31 |
| 25.4 | 1496.06 | 1498.25 | 1498.84 | 1498.84 | 1501.66 |
| 25.5 | 1496.32 | 1498.57 | 1499.05 | 1499.19 | 1502.00 |
| 25.6 | 1496.50 | 1498.70 | 1499.30 | 1499.38 | 1502.35 |
| 25.7 | 1496.28 | 1499.16 | 1499.55 | 1499.58 | 1502.70 |
| 25.8 | 1496.56 | 1499.39 | 1499.78 | 1499.88 | 1503.04 |
| 25.9 | 1496.81 | 1499.47 | 1499.92 | 1500.18 | 1503.39 |
| 26 | 1497.04 | 1499.81 | 1500.23 | 1500.36 | 1503.74 |
| 26.1 | 1497.34 | 1500.09 | 1500.43 | 1500.63 | 1504.09 |
| 26.2 | 1497.64 | 1500.46 | 1500.68 | 1500.86 | 1504.43 |
| 26.3 | 1497.86 | 1500.61 | 1501.06 | 1501.26 | 1504.78 |
| 26.4 | 1498.15 | 1500.90 | 1501.29 | 1501.44 | 1504.48 |
| 26.5 | 1498.45 | 1501.33 | 1501.50 | 1501.66 | 1503.98 |
| 26.6 | 1498.67 | 1501.47 | 1501.78 | 1501.89 | 1503.49 |
| 26.7 | 1498.95 | 1501.78 | 1502.08 | 1502.26 | 1503.37 |
| 26.8 | 1499.23 | 1502.12 | 1502.19 | 1502.42 | 1503.59 |
| 26.9 | 1499.43 | 1502.35 | 1502.39 | 1502.68 | 1503.81 |
| 27 | 1499.66 | 1502.58 | 1502.63 | 1502.98 | 1504.04 |
| 27.1 | 1499.93 | 1502.94 | 1502.93 | 1503.22 | 1504.26 |
| 27.2 | 1500.17 | 1503.02 | 1503.25 | 1503.32 | 1504.48 |
| 27.3 | 1500.39 | 1503.42 | 1503.29 | 1503.65 | 1504.70 |
| 27.4 | 1500.67 | 1503.70 | 1503.66 | 1503.96 | 1504.92 |
| 27.5 | 1500.94 | 1503.87 | 1503.90 | 1504.15 | 1505.14 |
| 27.6 | 1501.17 | 1504.32 | 1504.19 | 1504.39 | 1505.37 |
| 27.7 | 1501.42 | 1504.83 | 1504.48 | 1504.62 | 1505.59 |
| 27.8 | 1501.67 | 1505.11 | 1504.58 | 1504.80 | 1505.81 |
| 27.9 | 1501.89 | 1505.29 | 1504.72 | 1505.05 | 1506.03 |
| 28 | 1502.13 | 1505.68 | 1505.16 | 1505.36 | 1506.25 |
| 28.1 | 1502.41 | 1505.77 | 1505.29 | 1505.70 | 1506.47 |
| 28.2 | 1502.66 | 1506.14 | 1505.46 | 1505.84 | 1506.70 |
| 28.3 | 1502.91 | 1506.31 | 1505.90 | 1506.09 | 1506.92 |
| 28.4 | 1503.16 | 1506.52 | 1506.13 | 1506.40 | 1507.14 |
| 28.5 | 1503.40 | 1506.76 | 1506.29 | 1506.49 | 1507.36 |
| 28.6 | 1503.65 | 1507.06 | 1506.51 | 1506.83 | 1507.58 |
| 28.7 | 1503.88 | 1507.36 | 1506.87 | 1507.03 | 1507.80 |
| 28.8 | 1504.12 | 1507.59 | 1507.02 | 1507.21 | 1508.03 |
| 28.9 | 1504.34 | 1507.63 | 1507.22 | 1507.48 | 1508.25 |
| 29 | 1504.58 | 1507.92 | 1507.37 | 1507.65 | 1508.47 |
| 29.1 | 1504.81 | 1507.95 | 1507.62 | 1508.00 | 1508.69 |
| 29.2 | 1505.03 | 1508.12 | 1507.99 | 1508.16 | 1508.91 |
| 29.3 | 1505.26 | 1508.37 | 1508.06 | 1508.38 | 1509.14 |
| 29.4 | 1505.52 | 1508.53 | 1508.30 | 1508.68 | 1509.36 |
| 29.5 | 1505.73 | 1508.93 | 1508.55 | 1508.73 | 1509.58 |
| 29.6 | 1505.95 | 1509.13 | 1508.84 | 1509.05 | 1509.80 |
| 29.7 | 1506.19 | 1509.43 | 1509.04 | 1509.21 | 1510.02 |
| 29.8 | 1506.44 | 1509.66 | 1509.35 | 1509.60 | 1510.24 |
| 29.9 | 1506.65 | 1509.91 | 1509.51 | 1509.78 | 1510.47 |
| 30 | 1506.87 | 1509.90 | 1509.71 | 1509.93 | 1510.69 |
| 30.1 | 1507.14 | 1510.22 | 1509.93 | 1510.12 | 1510.91 |
| 30.2 | 1507.35 | 1510.59 | 1510.18 | 1510.34 | 1511.13 |
| 30.3 | 1507.58 | 1510.69 | 1510.53 | 1510.49 | 1511.35 |
| 30.4 | 1507.83 | 1510.96 | 1510.62 | 1510.86 | 1511.57 |
| 30.5 | 1508.06 | 1511.24 | 1510.85 | 1510.97 | 1511.80 |
| 30.6 | 1508.30 | 1511.46 | 1511.15 | 1511.35 | 1512.02 |
| 30.7 | 1508.52 | 1511.70 | 1511.32 | 1511.53 | 1512.24 |
| 30.8 | 1508.74 | 1511.77 | 1511.46 | 1511.62 | 1512.46 |
| 30.9 | 1508.94 | 1511.97 | 1511.65 | 1511.97 | 1512.68 |
| 31 | 1509.15 | 1512.33 | 1512.08 | 1512.19 | 1512.90 |
| 31.1 | 1509.38 | 1512.52 | 1512.30 | 1512.34 | 1513.13 |
| 31.2 | 1509.58 | 1512.87 | 1512.44 | 1512.60 | 1513.35 |
| 31.3 | 1509.81 | 1512.89 | 1512.64 | 1512.78 | 1513.57 |
| 31.4 | 1510.03 | 1513.08 | 1512.97 | 1512.97 | 1513.79 |
| 31.5 | 1510.26 | 1513.42 | 1513.15 | 1513.24 | 1514.01 |
| 31.6 | 1510.51 | 1513.60 | 1513.30 | 1513.39 | 1514.24 |
| 31.7 | 1510.71 | 1514.02 | 1513.55 | 1513.63 | 1514.46 |
| 31.8 | 1510.94 | 1514.19 | 1513.82 | 1513.80 | 1514.68 |
| 31.9 | 1511.17 | 1514.39 | 1513.99 | 1514.06 | 1514.90 |
| 32 | 1511.39 | 1514.57 | 1514.12 | 1514.40 | 1515.12 |
| 32.1 | 1511.60 | 1514.68 | 1514.54 | 1514.61 | 1515.34 |
| 32.2 | 1511.82 | 1514.88 | 1514.74 | 1514.68 | 1515.57 |
| 32.3 | 1512.07 | 1515.15 | 1514.89 | 1515.12 | 1515.79 |
| 32.4 | 1512.29 | 1515.45 | 1515.20 | 1515.19 | 1516.01 |
| 32.5 | 1512.50 | 1515.76 | 1515.44 | 1515.54 | 1516.23 |
| 32.6 | 1512.73 | 1515.94 | 1515.59 | 1515.79 | 1516.45 |
| 32.7 | 1512.95 | 1516.22 | 1515.68 | 1515.93 | 1516.67 |
| 32.8 | 1513.14 | 1516.37 | 1515.95 | 1516.13 | 1516.90 |
| 32.9 | 1513.34 | 1516.60 | 1516.20 | 1516.24 | 1517.12 |
| 33 | 1513.56 | 1516.87 | 1516.38 | 1516.53 | 1517.34 |
| 33.1 | 1513.76 | 1517.03 | 1516.65 | 1516.78 | 1517.56 |
| 33.2 | 1513.96 | 1517.18 | 1516.78 | 1517.02 | 1517.78 |
| 33.3 | 1514.20 | 1517.43 | 1516.98 | 1517.22 | 1518.01 |
| 33.4 | 1514.40 | 1517.70 | 1517.30 | 1517.39 | 1518.23 |
| 33.5 | 1514.60 | 1517.91 | 1517.35 | 1517.54 | 1518.45 |
| 33.6 | 1514.83 | 1518.18 | 1517.61 | 1517.80 | 1518.67 |
| 33.7 | 1515.05 | 1518.33 | 1517.86 | 1518.10 | 1518.89 |
| 33.8 | 1515.25 | 1518.38 | 1517.97 | 1518.23 | 1519.11 |
| 33.9 | 1515.44 | 1518.62 | 1518.16 | 1518.42 | 1519.34 |
| 34 | 1515.68 | 1518.84 | 1518.37 | 1518.60 | 1519.56 |
| 34.1 | 1515.89 | 1519.07 | 1518.59 | 1518.79 | 1519.78 |
| 34.2 | 1516.06 | 1519.40 | 1518.79 | 1518.97 | 1520.00 |
| 34.3 | 1516.27 | 1519.46 | 1519.05 | 1519.26 | 1520.22 |
| 34.4 | 1516.49 | 1519.74 | 1519.22 | 1519.55 | 1520.44 |
| 34.5 | 1516.64 | 1519.80 | 1519.35 | 1519.64 | 1520.50 |
| 34.6 | 1516.83 | 1520.11 | 1519.57 | 1519.83 | 1520.59 |
| 34.7 | 1517.06 | 1520.30 | 1519.92 | 1519.99 | 1520.77 |
| 34.8 | 1517.26 | 1520.63 | 1520.16 | 1520.19 | 1520.94 |
| 34.9 | 1517.40 | 1520.67 | 1520.25 | 1520.41 | 1521.05 |
| 35 | 1517.60 | 1520.86 | 1520.42 | 1520.70 | 1521.24 |
| 35.1 | 1517.82 | 1521.17 | 1520.51 | 1520.90 | 1521.44 |
| 35.2 | 1518.01 | 1521.18 | 1520.83 | 1521.05 | 1521.57 |
| 35.3 | 1518.19 | 1521.36 | 1521.10 | 1521.16 | 1521.77 |
| 35.4 | 1518.43 | 1521.59 | 1521.29 | 1521.38 | 1521.95 |
| 35.5 | 1518.65 | 1521.87 | 1521.43 | 1521.59 | 1522.13 |
| 35.6 | 1518.83 | 1522.21 | 1521.72 | 1521.80 | 1522.30 |
| 35.7 | 1519.05 | 1522.38 | 1521.91 | 1521.97 | 1522.49 |
| 35.8 | 1519.27 | 1522.38 | 1522.05 | 1522.35 | 1522.67 |
| 35.9 | 1519.43 | 1522.80 | 1522.29 | 1522.40 | 1522.80 |
| 36 | 1519.60 | 1522.73 | 1522.35 | 1522.53 | 1522.98 |
| 36.1 | 1519.82 | 1522.98 | 1522.60 | 1522.83 | 1523.19 |
| 36.2 | 1520.01 | 1523.18 | 1522.82 | 1522.98 | 1523.35 |
| 36.3 | 1520.16 | 1523.48 | 1522.86 | 1523.07 | 1523.48 |
| 36.4 | 1520.36 | 1523.58 | 1523.09 | 1523.41 | 1523.67 |
| 36.5 | 1520.58 | 1523.88 | 1523.34 | 1523.67 | 1523.87 |
| 36.6 | 1520.74 | 1523.98 | 1523.55 | 1523.67 | 1524.01 |
| 36.7 | 1520.92 | 1524.20 | 1523.69 | 1523.85 | 1524.20 |
| 36.8 | 1521.11 | 1524.25 | 1523.77 | 1524.23 | 1524.38 |
| 36.9 | 1521.31 | 1524.40 | 1523.98 | 1524.37 | 1524.55 |
| 37 | 1521.45 | 1524.64 | 1524.26 | 1524.45 | 1524.70 |
| 37.1 | 1521.66 | 1525.00 | 1524.33 | 1524.71 | 1524.86 |
| 37.2 | 1521.87 | 1525.17 | 1524.53 | 1524.85 | 1525.04 |
| 37.3 | 1522.07 | 1525.20 | 1524.88 | 1525.02 | 1525.20 |
| 37.4 | 1522.25 | 1525.52 | 1524.89 | 1525.29 | 1525.37 |
| 37.5 | 1522.47 | 1525.53 | 1525.30 | 1525.62 | 1525.56 |
| 37.6 | 1522.67 | 1525.75 | 1525.40 | 1525.81 | 1525.76 |
| 37.7 | 1522.82 | 1526.05 | 1525.46 | 1525.87 | 1525.89 |
| 37.8 | 1523.02 | 1526.32 | 1525.74 | 1526.05 | 1526.07 |
| 37.9 | 1523.23 | 1526.37 | 1526.01 | 1526.18 | 1526.27 |
| 38 | 1523.39 | 1526.53 | 1526.17 | 1526.34 | 1526.42 |
| 38.1 | 1523.55 | 1526.68 | 1526.32 | 1526.50 | 1526.58 |
| 38.2 | 1523.71 | 1526.84 | 1526.48 | 1526.66 | 1526.74 |
| 38.3 | 1523.87 | 1527.00 | 1526.64 | 1526.82 | 1526.89 |
| 38.4 | 1524.03 | 1527.16 | 1526.80 | 1526.98 | 1527.05 |
| 38.5 | 1524.19 | 1527.32 | 1526.95 | 1527.14 | 1527.20 |
| 38.6 | 1524.35 | 1527.48 | 1527.11 | 1527.30 | 1527.36 |
| 38.7 | 1524.51 | 1527.63 | 1527.27 | 1527.46 | 1527.52 |
| 38.8 | 1524.67 | 1527.79 | 1527.43 | 1527.62 | 1527.67 |
| 38.9 | 1524.83 | 1527.95 | 1527.58 | 1527.78 | 1527.83 |
| 39 | 1524.99 | 1528.11 | 1527.74 | 1527.93 | 1527.99 |
| 39.1 | 1525.15 | 1528.27 | 1527.90 | 1528.09 | 1528.14 |
| 39.2 | 1525.31 | 1528.42 | 1528.06 | 1528.25 | 1528.30 |
| 39.3 | 1525.47 | 1528.58 | 1528.21 | 1528.41 | 1528.46 |
| 39.4 | 1525.63 | 1528.74 | 1528.37 | 1528.57 | 1528.61 |
| 39.5 | 1525.79 | 1528.90 | 1528.53 | 1528.73 | 1528.77 |
| 39.6 | 1525.95 | 1529.06 | 1528.69 | 1528.89 | 1528.93 |
| 39.7 | 1526.11 | 1529.21 | 1528.85 | 1529.05 | 1529.08 |
| 39.8 | 1526.27 | 1529.37 | 1529.00 | 1529.21 | 1529.24 |
| 39.9 | 1526.43 | 1529.53 | 1529.16 | 1529.37 | 1529.40 |
| 40 | 1526.59 | 1529.69 | 1529.32 | 1529.53 | 1529.55 |
| 40.1 | 1526.75 | 1529.85 | 1529.48 | 1529.69 | 1529.71 |
| 40.2 | 1526.91 | 1530.00 | 1529.63 | 1529.85 | 1529.86 |
| 40.3 | 1527.07 | 1530.16 | 1529.79 | 1530.01 | 1530.02 |
| 40.4 | 1527.23 | 1530.32 | 1529.95 | 1530.17 | 1530.18 |
| 40.5 | 1527.39 | 1530.48 | 1530.11 | 1530.33 | 1530.33 |
| 40.6 | 1527.55 | 1530.64 | 1530.26 | 1530.49 | 1530.49 |
| 40.7 | 1527.71 | 1530.80 | 1530.42 | 1530.65 | 1530.65 |
| 40.8 | 1527.87 | 1530.95 | 1530.58 | 1530.80 | 1530.80 |
| 40.9 | 1528.03 | 1531.11 | 1530.74 | 1530.96 | 1530.96 |
| 41 | 1528.19 | 1531.27 | 1530.89 | 1531.12 | 1531.12 |
| 41.1 | 1528.35 | 1531.43 | 1531.05 | 1531.28 | 1531.27 |
| 41.2 | 1528.51 | 1531.59 | 1531.21 | 1531.44 | 1531.43 |
| 41.3 | 1528.67 | 1531.74 | 1531.37 | 1531.60 | 1531.59 |
| 41.4 | 1528.83 | 1531.90 | 1531.52 | 1531.76 | 1531.74 |
| 41.5 | 1528.99 | 1532.06 | 1531.68 | 1531.92 | 1531.90 |
| 41.6 | 1529.15 | 1532.22 | 1531.84 | 1532.08 | 1532.06 |
| 41.7 | 1529.31 | 1532.38 | 1532.00 | 1532.24 | 1532.21 |
| 41.8 | 1529.47 | 1532.53 | 1532.16 | 1532.40 | 1532.37 |
| 41.9 | 1529.63 | 1532.69 | 1532.31 | 1532.56 | 1532.52 |
| 42 | 1529.79 | 1532.85 | 1532.47 | 1532.72 | 1532.68 |
| 42.1 | 1529.95 | 1533.01 | 1532.63 | 1532.88 | 1532.84 |
| 42.2 | 1530.11 | 1533.17 | 1532.79 | 1533.04 | 1532.99 |
| 42.3 | 1530.27 | 1533.32 | 1532.94 | 1533.20 | 1533.15 |
| 42.4 | 1530.43 | 1533.48 | 1533.10 | 1533.36 | 1533.31 |
| 42.5 | 1530.59 | 1533.64 | 1533.26 | 1533.51 | 1533.46 |
| 42.6 | 1530.75 | 1533.80 | 1533.42 | 1533.67 | 1533.62 |
| 42.7 | 1530.91 | 1533.96 | 1533.57 | 1533.83 | 1533.78 |
| 42.8 | 1531.07 | 1534.12 | 1533.73 | 1533.99 | 1533.93 |
| 42.9 | 1531.23 | 1534.27 | 1533.89 | 1534.15 | 1534.09 |
| 43 | 1531.39 | 1534.43 | 1534.05 | 1534.31 | 1534.25 |
| 43.1 | 1531.55 | 1534.59 | 1534.20 | 1534.47 | 1534.40 |
| 43.2 | 1531.71 | 1534.75 | 1534.36 | 1534.63 | 1534.56 |
| 43.3 | 1531.87 | 1534.91 | 1534.52 | 1534.79 | 1534.72 |
| 43.4 | 1532.03 | 1535.06 | 1534.68 | 1534.95 | 1534.87 |
| 43.5 | 1532.19 | 1535.22 | 1534.83 | 1535.11 | 1535.03 |
| 43.6 | 1532.35 | 1535.38 | 1534.99 | 1535.27 | 1535.18 |
| 43.7 | 1532.51 | 1535.54 | 1535.15 | 1535.43 | 1535.34 |
| 43.8 | 1532.67 | 1535.70 | 1535.31 | 1535.59 | 1535.50 |
| 43.9 | 1532.84 | 1535.85 | 1535.47 | 1535.75 | 1535.65 |
| 44 | 1533.00 | 1536.01 | 1535.62 | 1535.91 | 1535.81 |
| 44.1 | 1533.16 | 1536.17 | 1535.78 | 1536.07 | 1535.97 |
| 44.2 | 1533.32 | 1536.33 | 1535.94 | 1536.23 | 1536.12 |
| 44.3 | 1533.48 | 1536.49 | 1536.10 | 1536.38 | 1536.28 |
| 44.4 | 1533.64 | 1536.64 | 1536.25 | 1536.54 | 1536.44 |
| 44.5 | 1533.80 | 1536.80 | 1536.41 | 1536.70 | 1536.59 |
| 44.6 | 1533.96 | 1536.96 | 1536.57 | 1536.86 | 1536.75 |
| 44.7 | 1534.12 | 1537.12 | 1536.73 | 1537.02 | 1536.91 |
| 44.8 | 1534.28 | 1537.28 | 1536.88 | 1537.18 | 1537.06 |
| 44.9 | 1534.44 | 1537.44 | 1537.04 | 1537.34 | 1537.22 |
| 45 | 1534.60 | 1537.59 | 1537.20 | 1537.50 | 1537.38 |
| 45.1 | 1534.72 | 1537.65 | 1537.18 | 1537.57 | 1537.49 |
| 45.2 | 1534.85 | 1537.71 | 1537.31 | 1537.59 | 1537.61 |
| 45.3 | 1535.01 | 1537.80 | 1537.64 | 1537.80 | 1537.72 |
| 45.4 | 1535.16 | 1538.01 | 1537.71 | 1538.06 | 1537.84 |
| 45.5 | 1535.27 | 1538.18 | 1537.85 | 1538.15 | 1537.95 |
| 45.6 | 1535.39 | 1538.38 | 1537.95 | 1538.12 | 1538.07 |
| 45.7 | 1535.56 | 1538.53 | 1538.21 | 1538.27 | 1538.19 |
| 45.8 | 1535.70 | 1538.55 | 1538.30 | 1538.43 | 1538.26 |
| 45.9 | 1535.79 | 1538.71 | 1538.43 | 1538.51 | 1538.35 |
| 46 | 1535.92 | 1538.86 | 1538.55 | 1538.65 | 1538.47 |
| 46.1 | 1536.09 | 1538.94 | 1538.73 | 1538.98 | 1538.61 |
| 46.2 | 1536.24 | 1539.07 | 1538.85 | 1539.03 | 1538.74 |
| 46.3 | 1536.33 | 1539.07 | 1538.98 | 1539.09 | 1538.82 |
| 46.4 | 1536.47 | 1539.18 | 1539.10 | 1539.23 | 1538.94 |
| 46.5 | 1536.61 | 1539.49 | 1539.23 | 1539.29 | 1539.08 |
| 46.6 | 1536.74 | 1539.70 | 1539.34 | 1539.49 | 1539.19 |
| 46.7 | 1536.85 | 1539.68 | 1539.38 | 1539.51 | 1539.28 |
| 46.8 | 1536.99 | 1539.91 | 1539.48 | 1539.69 | 1539.40 |
| 46.9 | 1537.13 | 1540.01 | 1539.56 | 1539.85 | 1539.53 |
| 47 | 1537.25 | 1540.00 | 1539.71 | 1540.09 | 1539.62 |
| 47.1 | 1537.36 | 1540.23 | 1539.94 | 1540.08 | 1539.71 |
| 47.2 | 1537.51 | 1540.31 | 1540.08 | 1540.27 | 1539.85 |
| 47.3 | 1537.62 | 1540.45 | 1540.23 | 1540.33 | 1539.98 |
| 47.4 | 1537.65 | 1540.68 | 1540.30 | 1540.46 | 1540.07 |
| 47.5 | 1537.75 | 1540.58 | 1540.33 | 1540.72 | 1540.17 |
| 47.6 | 1537.93 | 1540.68 | 1540.55 | 1540.81 | 1540.30 |
| 47.7 | 1538.18 | 1541.18 | 1540.84 | 1541.05 | 1540.42 |
| 47.8 | 1538.28 | 1541.22 | 1540.87 | 1541.09 | 1540.47 |
| 47.9 | 1538.41 | 1541.39 | 1540.99 | 1541.20 | 1540.57 |
| 48 | 1538.56 | 1541.43 | 1541.25 | 1541.48 | 1540.71 |
| 48.1 | 1538.68 | 1541.48 | 1541.40 | 1541.59 | 1540.84 |
| 48.2 | 1538.78 | 1541.56 | 1541.33 | 1541.52 | 1540.90 |
| 48.3 | 1538.90 | 1541.60 | 1541.55 | 1541.80 | 1540.99 |
| 48.4 | 1539.03 | 1541.75 | 1541.56 | 1541.92 | 1541.13 |
| 48.5 | 1539.15 | 1541.90 | 1541.86 | 1541.88 | 1541.24 |
| 48.6 | 1539.25 | 1542.20 | 1541.90 | 1542.14 | 1541.31 |
| 48.7 | 1539.36 | 1542.23 | 1541.95 | 1542.27 | 1541.40 |
| 48.8 | 1539.50 | 1542.33 | 1542.04 | 1542.26 | 1541.53 |
| 48.9 | 1539.63 | 1542.36 | 1542.33 | 1542.39 | 1541.62 |
| 49 | 1539.72 | 1542.48 | 1542.35 | 1542.49 | 1541.70 |
| 49.1 | 1539.84 | 1542.48 | 1542.49 | 1542.70 | 1541.79 |
| 49.2 | 1539.96 | 1542.72 | 1542.65 | 1542.74 | 1541.92 |
| 49.3 | 1540.08 | 1542.92 | 1542.56 | 1542.94 | 1542.03 |
| 49.4 | 1540.17 | 1542.99 | 1542.70 | 1542.97 | 1542.11 |
| 49.5 | 1540.16 | 1542.92 | 1542.78 | 1542.72 | 1542.21 |
| 49.6 | 1540.28 | 1542.98 | 1542.90 | 1542.82 | 1542.32 |
| 49.7 | 1540.40 | 1543.23 | 1543.02 | 1543.04 | 1542.43 |
| 49.8 | 1540.48 | 1543.23 | 1543.08 | 1543.04 | 1542.49 |
| 49.9 | 1540.60 | 1543.36 | 1543.26 | 1543.23 | 1542.60 |
| 50 | 1540.74 | 1543.34 | 1543.36 | 1543.24 | 1542.71 |

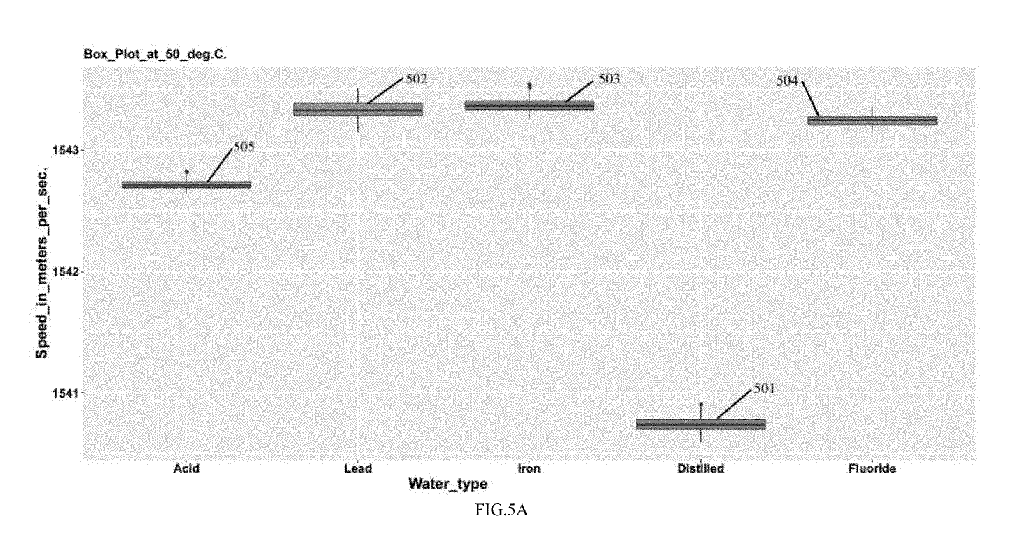

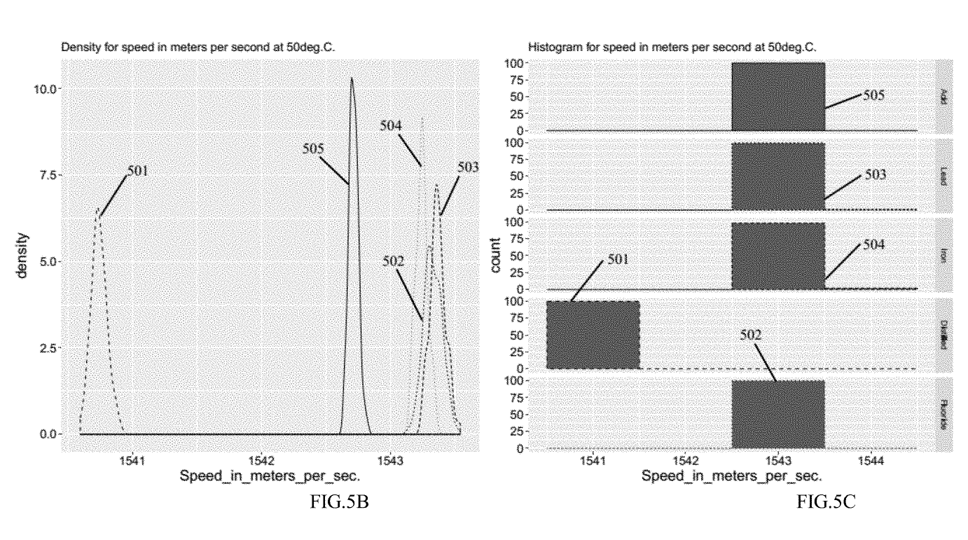

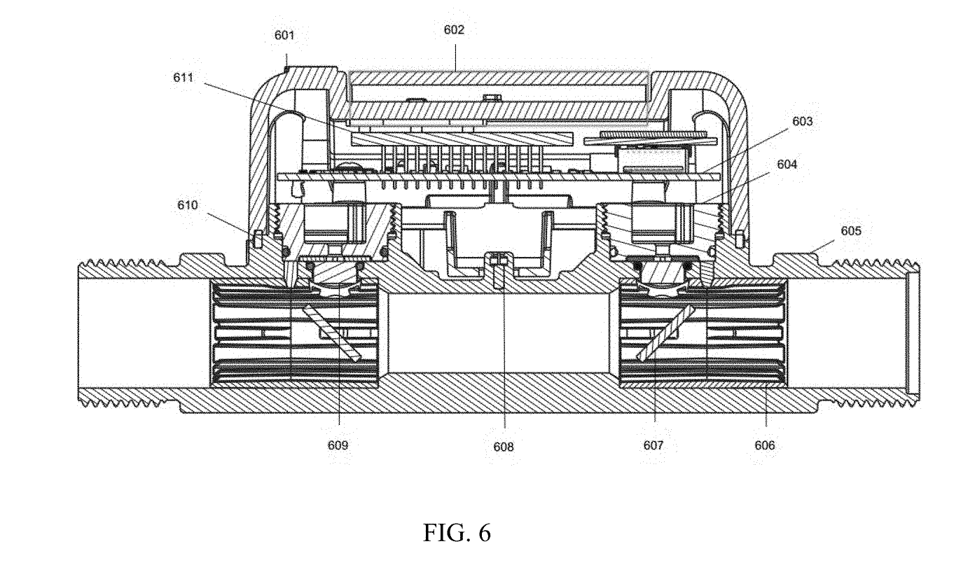

FIG. 6 is a cross-section bottom-view of a straight tube ultrasonic flow meter embodiment. Shown are top cover 601, display cover 602, transducer nut 604, straight tube bottom cover 605, reflector ring 606, reflector 607, temperature sensor 608, transducer 609, enclosure seal 610, LCD display 611 and a signal processing unit comprising a PCB board 603.

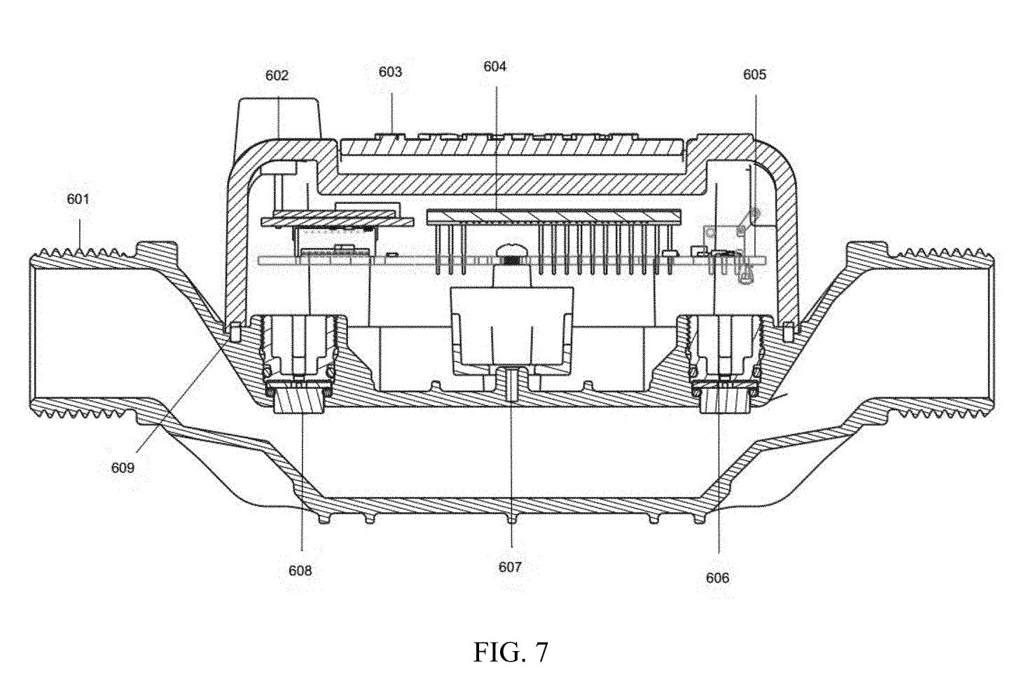

FIG. 7 is a cross-section bottom-view of a U-shaped tube ultrasonic flow meter embodiment. Shown are top cover 601, display cover 602, signal processing unit comprising a PCB board 603, transducer nut 604, U-shaped tube bottom cover 701, temperature sensor 608, transducer 609, enclosure seal 610, and LCD display 611.

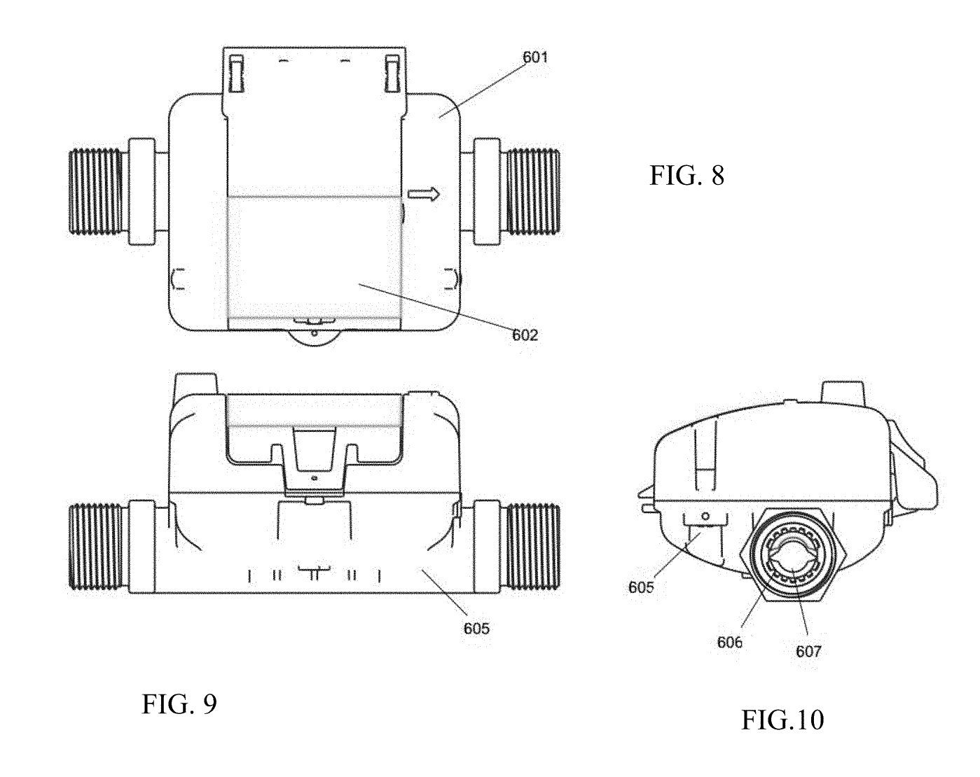

FIG. 8 is a front view of a straight tube ultrasonic flow meter embodiment. Shown are top cover 601 and display cover 602.

FIG. 9 is a bottom view of a straight tube ultrasonic flow meter embodiment. Shown is straight tube bottom cover 605.

FIG. 10 is a right-side view of a straight tube ultrasonic flow meter embodiment. Shown are straight tube bottom cover 605, reflector ring 606, and reflector 607.

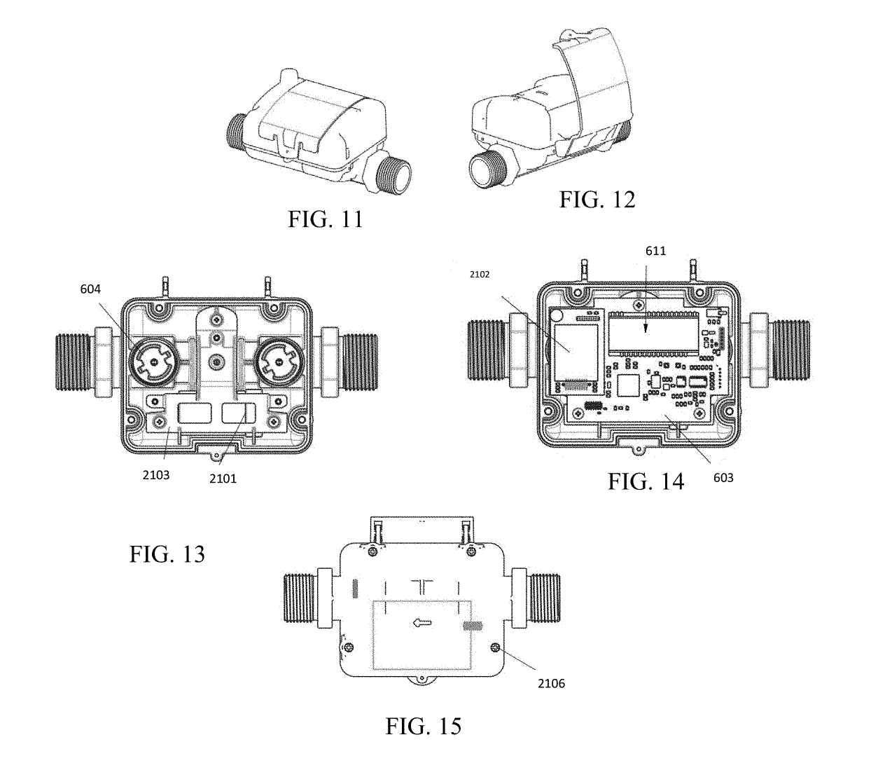

FIG. 11 is a left-back perspective view of a straight tube ultrasonic flow meter embodiment.

FIG. 12 is a right-front of a straight tube ultrasonic flow meter embodiment.

FIG. 13 is a front view without the enclosure cover of a straight tube ultrasonic flow meter embodiment. Shown are transducer nut 604, battery 2101 and PCB frame 2103.

FIG. 14 is a front view without the enclosure cover that shows a signal processing unit layout for a straight tube ultrasonic flow meter embodiment. Shown are PCB board 603, LCD display 611, and PCB wireless module assembly 2102.

FIG. 15 is a top view top view of a straight tube ultrasonic flow meter embodiment. Shown is screw (seal) 2106.

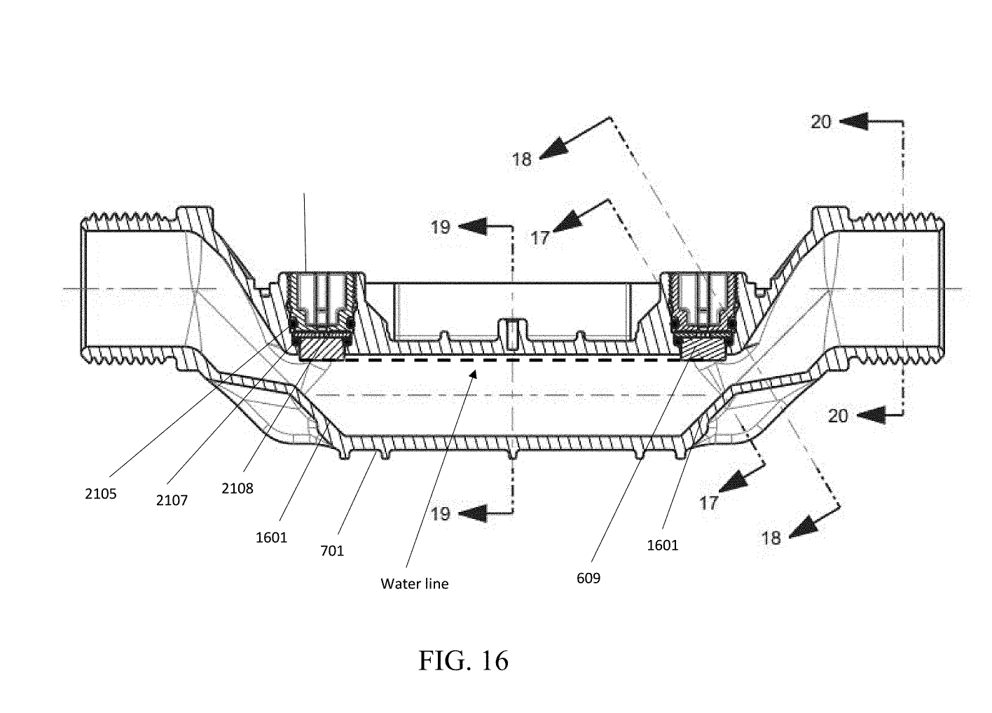

FIG. 16 is cross-section bottom-view of a U-shaped tube ultrasonic flow meter embodiment that provides additional detail and gives cut-section locations. Shown are section 17-17, section 18-18, section 19-19, section 20-20, transducer nut 604, U-shaped tube bottom cover 701, ring seal 2105, lower seal 2107, upper seal 2108, reflective surfaces 1601, and water level line 1602.

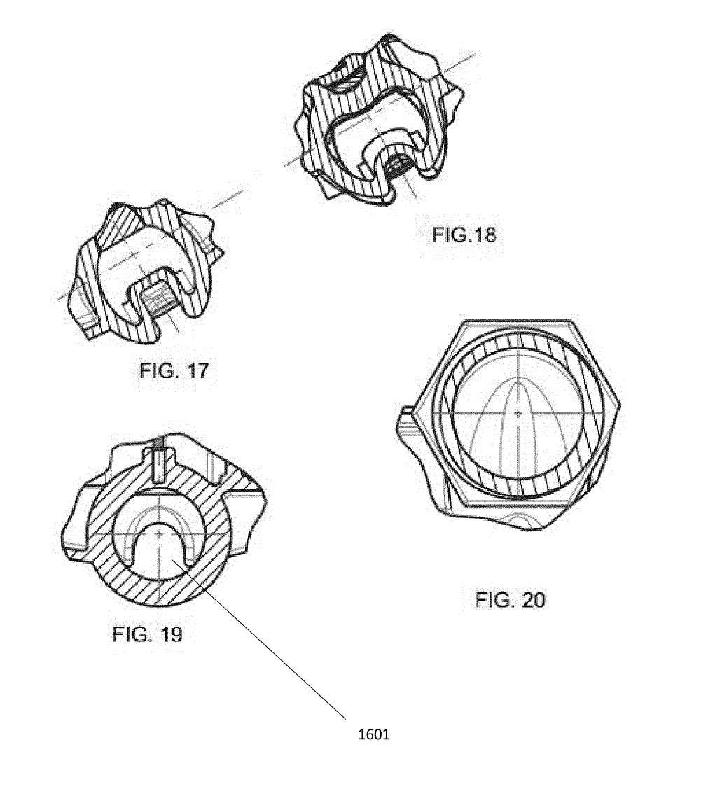

FIG. 17 shows a first cut-section.

FIG. 18 shows a second cut-section.

FIG. 19 shows a third cut-section.

FIG. 20 shows a fourth cut-section. Shown is a reflective surface 1601.

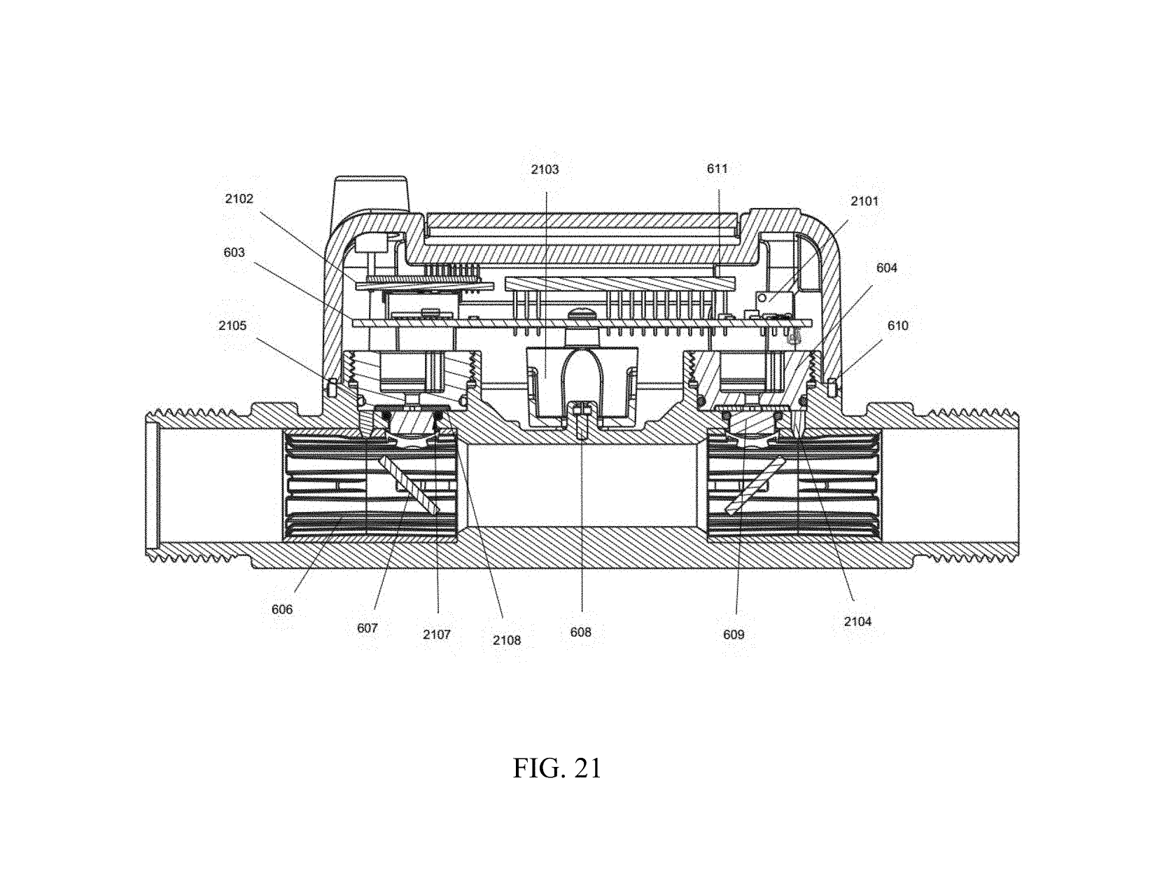

FIG. 21 is a cross-section bottom-view of a straight tube ultrasonic flow meter embodiment that gives additional detail. Shown are PCB board 603, transducer nut 604, reflector ring 606, reflector 607, temperature sensor 608, transducer 609, enclosure seal 610, LCD display 611, battery 2101, PCB wireless module assembly 2102, PCB frame 2103, locator pin 2104, ring seal 2105, lower seal 2107, and upper seal 2108.

The mechanical construction of the ultrasonic flowmeter along the water passage/pipe, FIG. 21, is made in a way that will cause the minimum pressure drop and disturbance achievable. The water passage line contains the reflector ring assembly which comprises reflector 607 and reflector ring 608, the ultrasonic transducer 609 and locator pin 2104 placed on each side of the flow passage. These components are placed mirrored to each other at each end of the flow passage.

The ultrasonic transducers 609 are placed on the bottom cover 605 facing downwards into the water flow passage (pipe) secured with lower seal 2107 and upper seal 2108. The transducer nut 604 above the ultrasonic transducer 609 will accurately position the ultrasonic transducer 609 to the required vertical height. From this position, the ultrasonic transducer 609 will be able to generate and receive ultrasonic signals through its frontal bottom face that is faced downwards to the Reflector 607 and/or the water passage.

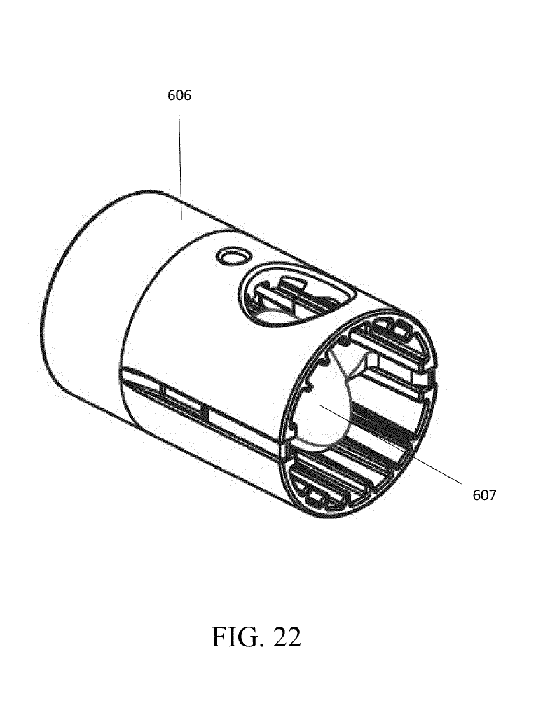

FIG. 22 is a perspective view of a reflector ring assembly. The reflector ring assembly comprises the reflector 607 and reflector ring 606. The reflector ring assembly has a primary role of providing ultrasonic signal reflective surface at the exact position and 45 degrees angle from the axis of the flow passage (pipe), and a secondary role of reducing disturbance by streamlining and guiding the water that flows through it. Swirling and other disturbances could be generated in the flowing water streamline by pipe elements assembled prior to the meter. The reflector ring 606 has ribs around its inner surface that are constructed along the streamline. These ribs come into contact with the outer layers of the fluid streamline flowing through it and guide it. For the outer layers of the fluid streamlines that come in contact with the ribs, their transverse (rotational about the axis of the pipe) components of the velocity are canceled, while the horizontal (along streamline) velocity component is allowed to pass. This operation will help reduce other components of the velocity of the fluid flowing through the reflector rings 606.

In one embodiment, the reflector 607 is a stainless steel part that is designed to provide a rigid and highly reflective (mirror) surface at 45 degrees from its horizontal tabs (pipe axis). The shape and size of the part is optimized to make it withstand up to 3 Mpa of fluid pressure without distortion with minimal pressure drop and easy assembly capability.

The locator pin 2104 is the component that fixes the reflector ring assembly in an accurate position.

The narrowed diameter of the bottom cover 605 at the middle of the water passage is carefully optimized so that it gives good compromise between two critical parameters of pressure drop and flow velocity of fluid between the reflectors (at the middle section). The increase in velocity is required as it helps in increasing the difference of transit time in the forward and backward signal transmission. The increase in time difference in turn assists signal filtration.

The U-shaped tube embodiment is described below. This embodiment is a total replacement alternative of the first variant where the ultrasonic flowmeter is to be used in residents where the water supply system has relatively low pressure at the resident distribution networks. This results in very low pressure flow and partial flow conditions inside the meter, which could disturb the ultrasonic signal transmission. Therefore, for such conditions of applications, the U-shaped tube embodiment is preferred so that it overcomes such problems.

The bottom cover 701 is constructed in a way that minimizes pressure losses and minimizes changes to the flow profile of water flowing through it. The features of this part inside the water passage are streamlined, optimized in shape and size so that they will have low resistance and disturbance to the flow. The bottom cover 701 is symmetric on each side of the section plane 20-20 and has two very fine reflective surfaces 1601 integrated within it. The reflective surfaces are highly polished ultrasonic signal reflecting planar inside surfaces at 45 degrees from the horizontal plane/the flow passage (pipe) axis. These surfaces replace and serve the purpose of reflector 607 of the straight tube embodiment as discussed above.

The U-shaped tube embodiment design fulfills the following purposes: 1) The design enables the ultrasonic signal transmission to be uninterrupted in low water pressure systems. It allows the transducers to be always immersed in water whether the flow pressure is very low and/or the flow is partial (partially filled by air) or not. 2) During very low pressure partial flow, the fluid flowing through the pipe section of the meter tends to leave air in the top section of the pipe while the water settles/flows at the bottom section of the pipe. This type of flow tends to incorporate air inside the pipe section between the transducers, which disturbs the measurement.

Therefore the U-shaped tube embodiment mitigates air entrapment by utilizing gravity to isolate air contained in partial flow. When low pressure partial flowing water enters the meter, the upper portion of the flow will be contained by air while the lower portion will be water. As the flow continues through the pipe, to the left) it passes through the inclined section (typical cross sections shown by auxiliary section views 18-18 and 19-19. Here the water tends to maintain the level indicated by water level line 1602 shown in FIG. 16, while leaving the air behind at the top section of the pipe (around section plane 17-17). The flow continues to follow this pattern through the meter and go out until higher pressure isn't applied from the distribution network. This aids the transducers to function well as the signal transmission is totally in a single media (e.g. water).

On the other hand, when the water flow supplied doesn't contain trapped air but has very low pressure, the flow will be normal until it passes the second transducer. Then the flow will tend to be partial flow condition when it reaches the lower level of the other end outlet of the meter. At this point, if the outlet of the meter isn't connected to a one way valve or similar device, air will enter through the water tap and comes up to the front indicated by the red line, where it stops. Due to gravitational separation, the air/gas will not pass further from around this point. This saves the communication from disturbance created by partially air filled communication media.

The above described low pressure and partial flow conditions are the worst case scenarios that could be a potential risk for the measurement. But it doesn't mean that low pressure and partial flow conditions in water supply networks near to the meter will behave exactly like this. This flow conditions are highly dependent on the pipe network elements before and after the meter. But the design considers the worst cases that could happen.

An additional objective is to reduce the number of components in the U-shaped tube embodiment assembly. Since the reflective surface is an integral part of the bottom cover 701, the total number of components required in the bottom cover assembly of the U-shaped tube embodiment has decreased by six. This increases the reliability of the ultrasonic flowmeter.

All patents and publications mentioned in the prior art are indicative of the levels of those skilled in the art to which the invention pertains. All patents and publications are herein incorporated by reference to the same extent as if each individual publication was specifically and individually indicated to be incorporated by reference, to the extent that they do not conflict with this disclosure.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations, and broad equivalent arrangements.

We claim:

1. An ultrasonic flow meter comprising:
at least one ultrasonic transducer; and
a signal processing unit for processing ultrasonic signals received from the at least one ultrasonic transducer, wherein the signal processing unit is configured to detect at least one impurity in a fluid as a function of a deviation in a measured travel speed of an ultrasonic signal in the fluid.

2. The meter of claim 1, wherein the fluid is water.

3. The meter of claim 1, wherein the at least one impurity is selected from the group consisting of an acid (Sulfuric), fluoride, iron, lead, and a combination thereof.

4. The meter of claim 1, wherein the signal processing unit is also configured to detect the at least one impurity in the fluid across a range of 0 to 100 degrees Celsius.

5. The meter of claim 1, wherein the deviation in the measured travel speed is between 1.5 and 2.0 meters per second.

6. The meter of claim 1, further wherein the transducer is mounted within a u-shaped tube, through which the fluid flows.

7. The meter of claim 1, further wherein the transducer is mounted within a straight tube, through which the fluid flows.

8. A method comprising:
providing the meter of claim 1;
filling the meter with a fluid; and
testing for at least one impurity in the fluid, wherein the test is a function of a deviation in a measured travel speed of an ultrasonic signal in the fluid.

9. The method of claim 8, wherein the fluid is water.

10. The method of claim 8, wherein the at least one impurity is selected from the group consisting of an acid (Sulfuric), fluoride, iron, lead, and a combination thereof.

11. The method of claim 8, wherein the signal processing unit is also configured to detect the at least one impurity in the fluid across a range of 0 to 100 degrees Celsius.

12. The method of claim 8, wherein the deviation in the measured travel speed is between 1.5 and 2.0 meters per second.

13. The method of claim 8, further wherein the transducer is mounted within a u-shaped tube, through which the fluid flows.

14. The method of claim 8, further wherein the transducer is mounted within a straight tube, through which the fluid flows.
